(19) United States
(12) Patent Application Publication
(10) Pub. No.: US 2004/0227362 A1
(43) Pub. Date: Nov. 18, 2004

(54) Container having a handle body attachable to the outside of the container

(76) Inventor: Wolfgang Fischbach, Daaden (DE)

Correspondence Address: FLYNN THIEL BOUTELL & TANIS, P.C., 2026 RAMBLING ROAD, KALAMAZOO, MI, 49008-1699, US

(21) Appl. No.: 10/846,077

(22) Filed: May 14, 2004

(30) Foreign Application Priority Data
May 16, 2003 (DE) 103 22 409.2

(51) Int. Cl. B25B 13/52

(52) U.S. Cl. 292/336.3

(57) ABSTRACT

This invention relates to a container (01) having a handle body (04) that can be attached to the container (01), whereby a mounting element (03) is situated on the outside of the container (01) and a recess (05) is provided in the handle body (04), the mounting element (03) being insertable into the recess in a form-fitting manner, and a fastening element (07) being engaged between the handle body (04) and the mounting element (03), thereby securing the handle body (04) on the mounting element (03). The fastening element is designed in the manner of a polygonal element (07) which can be brought to engagement in a form-fitting and/or frictionally engaged manner with a plurality of fastening edges on the handle body (04) and/or on the mounting element (03).

This invention relates to a container having a handle body attachable to the outside of the container according to the definition of the species of claim 1.

Generic containers are used in the manner of kitchen utensils (e.g., pots, pans), for example. Because such kitchen utensils are heated during use, thermally insulated handles are usually attached to the outside of the container so that the container or parts of the container, e.g., a lid can be handled.

For fastening the handle body on the container, so-called plug connections are frequently used. To this end, one or more mounting elements, e.g., mounting bolts, are attached to the container so that the handle body can be attached to the bolt in a form-fitting manner with a suitably shaped recess in the handle body. For fastening the handle body to the mounting element, fastening elements are used between the body of the handle body and the mounting element.

German Patent DE 38 05 229 A1 describes such a container with a handle body attached to it. A fastening spring is used as the fastening element for fastening the handle body; when the handle body is attached, the spring engages in an undercut in the recess. One disadvantage of this design is that the maximum mounting force that can be applied by the spring element is not very great. In addition, arranging the spring element between the handle body and the mounting element requires very accurate manufacturing tolerances and requires that an undercut be created in the recess.

Against the background of this state of the art, the object of the present invention is therefore to propose a novel container which avoids the disadvantages of the containers known from the state of the art.

This object is achieved by a container according to the teaching of claim 1.

Advantageous embodiments of this invention are the object of the subclaims.

This invention is based on the fundamental idea of providing a polygonal element between the handle body and the meeting element such that the polygonal element engages in a form-fitting and/or non-positive and/or frictionally engaged manner with several fastening edges on the handle body and/or on the retaining element. Because of the plurality of fastening edges, the maximum mounting force that can be transmitted by the polygonal element is obtained by adding up the retaining forces applied by each individual fastening edge. As a result, the problem solution according to this invention makes it possible to increase the maximum mounting force that can be applied by increasing the number of fastening edges and to do so in a simple way.

According to a preferred embodiment of this invention, the inside clearance between the wall of the handle body and the wall of the retaining element in the area of the polygonal element is at least slightly smaller than the corresponding width of the polygonal element. This achieves the result that the polygonal element is deformed at least slightly between the handle body and the retaining element by attaching the handle body. The clamping force thereby applied acts between the fastening edges of the polygonal element and the adjacent surface of the handle body and/or the retaining element, which ultimately results in a considerable increase in the retaining force that can be transmitted by each individual fastening edge.

To simplify assembly of the polygonal element when attaching the handle body to the retaining element, an indentation may be provided on the handle body and/or on the retaining element into which the polygonal element is placed before inserting it. The indentation guides the polygonal element in attaching the handle body and ensures a defined arrangement of the polygonal body between the handle body and the retaining element.

The indentation should preferably have on one side a stop surface against which the polygonal element comes to rest when attaching the handle body. The force required for attaching the polygonal element can be transmitted via this stop.

Especially high mounting and/or pull-away forces are obtained when the fastening edges of the polygonal element form a barb structure with the arrangement of the polygonal element between the handle body and the mounting element. In other words, this means that the fastening edges point in one direction which is opposite the pull-away direction at least to some extent. This achieves the result that the fastening edges always dig deeper into the surface of the handle body and/or the mounting element when a pull-away force is applied, thereby increasing the mounting force. The abutment structure thus produces a blocking effect when pulling off the handle so that unwanted loosening of the handle from the container is reliably prevented.

Essentially it does not matter what shape the polygonal element has as long as a sufficient number of fastening edges are provided. An especially simple and inexpensive variant uses a helical spring as the polygonal element. The outside circumference of the coils of the helical spring acts as fastening edges in the contact area with the mounting element and/or with the handle part. The design of the fastening edges depends on the cross section of the helical spring, which may be round or prismatic, for example. In the case of a round cross section, the fastening edges are in the shape of an arc of a circle.

The mounting element may essentially have any design. According to a first preferred embodiment, the mounting element is designed in the manner of a mounting bolt made of stainless steel or aluminum, for example. As an alternative, the mounting element may also be designed in the manner of a flexible sheet metal part.

It is particularly advantageous if the mounting element has an open or closed prismatic cross section, in particular a rectangular cross section. The polygonal element is then brought to engagement at one edge or corner of the mounting element. This achieves the result that the mounting element is pressed by the polygonal element against one side of the recess, thus resulting in a tolerance-free seating of the mounting element in the recess of the handle piece. As a result the manufacturing tolerances in manufacturing the recess in the handle piece and/or in manufacturing the mounting element can be increased without thereby endangering the tolerance-free seating of the handle piece.

Various embodiments of this invention are illustrated schematically in the drawings and are explained below as examples.

They show:

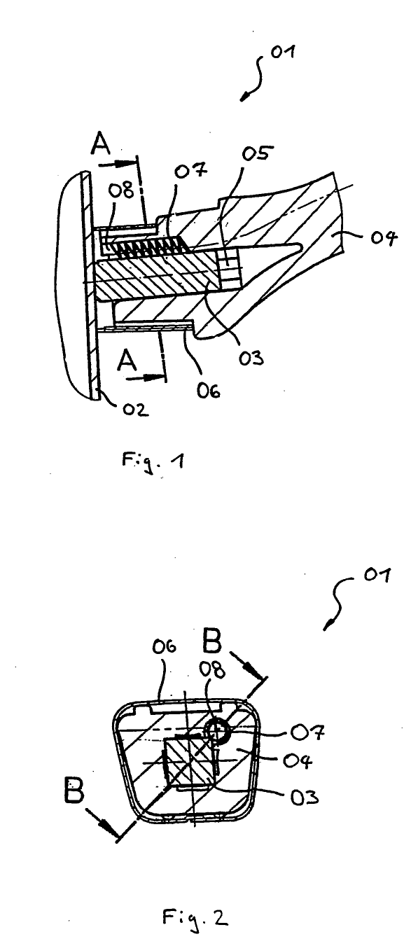

FIG. 1: a first embodiment of an inventive container having a handle piece in a longitudinal section along cross-sectional line B-B;

FIG. 2: the container according to FIG. 1 in cross section along cross-sectional line A-A;

FIG. 3: the container according to FIG. 1 in an enlarged longitudinal section;

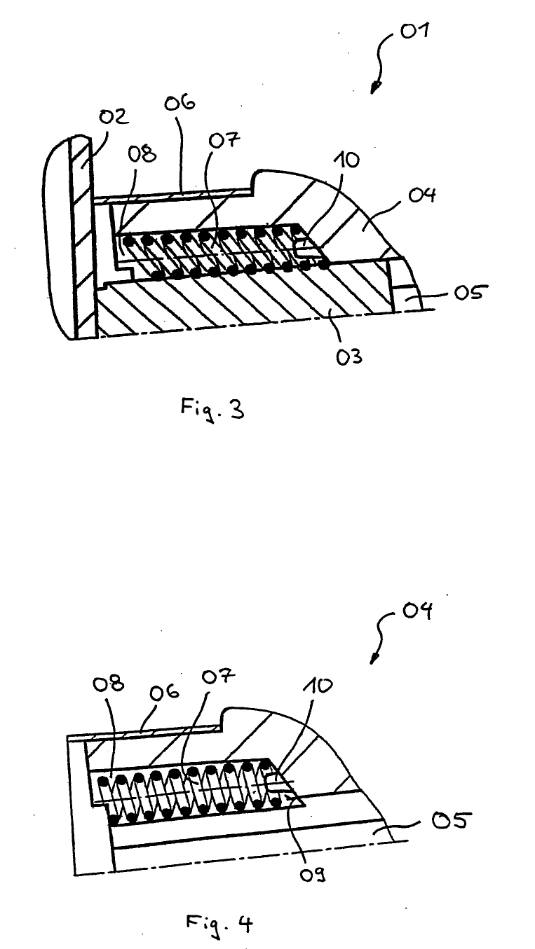

FIG. 4: the handle piece with the polygonal element of the container according to FIG. 1 in the unmounted state;

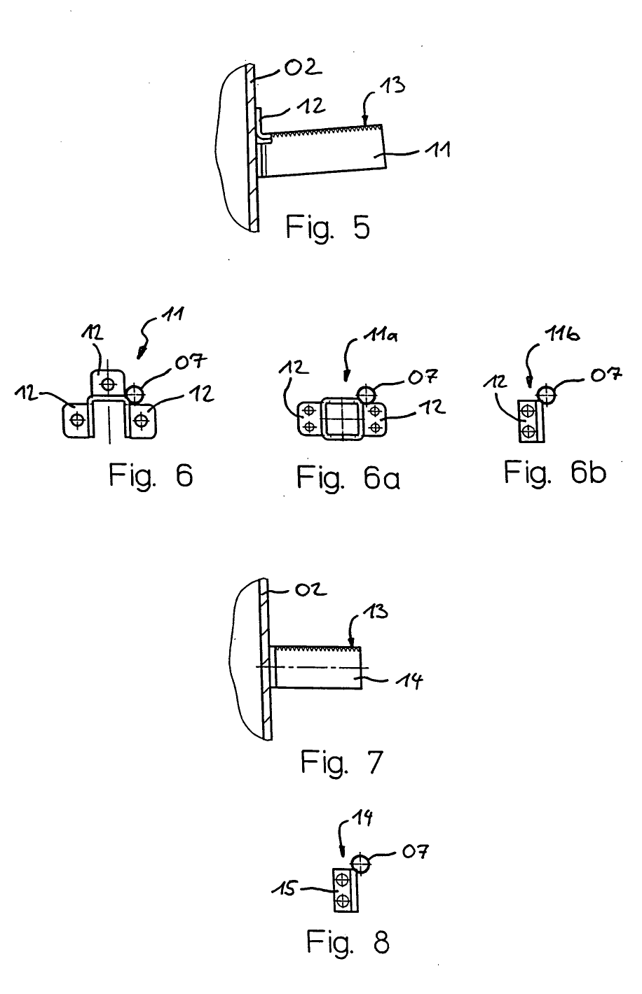

FIG. 5: a second embodiment of a mounting element in a side view;

FIG. 6: the mounting element according to FIG. 5 in a view from the front;

FIG. 6a: the mounting element according to FIG. 5 in an alternative embodiment in a view from the front;

FIG. 6b: the mounting element according to FIG. 5 in an alternative embodiment in a view from the front;

FIG. 7: a third embodiment of a mounting element in a side view;

FIG. 8: the mounting element according to FIG. 7 in a view from the front.

FIG. 1 shows a detail of an embodiment of an inventive container 01 in a longitudinal section. On the outside of the wall 02 of the container 01 there is a mounting element 03 which is designed in the manner of a prismatic mounting bolt made of aluminum. The mounting element 03 can be fastened onto the container wall 02 by welding, riveting or soldering, for example.

A handle body 06, which is designed in the manner of a stylus, may be attached to the mounting element 03. Therefore, a prismatic recess 05 is provided on one end of the handle body 04, its shape allowing the handle body 04 to be-placed on the mounting element 03 without play. The flanks of the recesses have offset undercuts in the area of the mounting element, so that a form-fitting connection between the mounting element and the handle piece is achieved only in the area of the corners of the recess.

The transitional area between the handle body 04 and the container wall 02 is covered toward the outside by means of a cuff 06 made of sheet metal, for example.

A polygonal element 07 is provided for fastening the handle body 04 on the mounting element 03; in the embodiment shown here it is designed in the manner of a helical spring made of steel wire. A circular indentation 08 is provided for guiding the polygonal element 07 in the handle body 04, its diameter being slightly larger than the diameter of the helical spring used as the polygonal element 07. The indentation 08 is arranged in such a way that one corner of the square recess 05 is cut by the circular indentation 08. This achieves the result that the helical spring 07 arranged in the indentation 08 forms a form-fitting and/or non-positive and/or frictionally engaged connection when the handle body 04 is placed on one corner of the mounting element 03.

The size ratios of the recess 05, the indentation 08 and the polygonal element 07 can be seen in FIG. 4, showing the handle body 04 in the unmounted state. The helical spring used as the polygonal element 07 protrudes a certain distance into the recess 05. On the side of the indentation 08 facing away from the wall 02 of the container, a stop surface 09 is provided on which the end cross section of the helical spring 07 can come to rest. As shown in FIG. 4, the stop surface 09 is inclined with respect to the end cross section of the helical spring 07 so that the windings of the helical spring 07 can be wrapped around the shape of the helical spring 07 at an angle due to the end cross section coming to rest against the stop surface 09. For guiding the helical spring 07 a centering mandrel 10 is provided in the stop surface 09. Due to the directional shaping of the windings of the helical spring 07, an abutment structure is formed as a result so that the fastening edges formed by the windings of the helical spring 07 effectively counteract the removal force applied in use of the container.

FIG. 3 shows the deformed state of the helical spring 07 after attaching the handle body 04 to the mounting element 03. Because of the fact that the handle piece 04 is made of plastic and the mounting element 03 is made of aluminum, it is possible for the windings of the helical spring 07 to cut a certain distance into the surface of the mounting element 03 and the handle body 04. As a result, this forms a form-fitting and/or non-positive and/or frictionally engaged connection between the helical spring 07 on the one hand and the handle body 04 and/or the mounting element 03 on the other hand. Because of the plurality of windings on the helical spring 07 and the correspondingly high number of fastening edges, very high pull-away forces can therefore be implemented.

FIGS. 5 and 6 show other second embodiments of mounting elements that can be used for the container according to this invention. The mounting element 11 which is shown in a side view in FIG. 5 is designed in the manner of a flexible sheet metal part which can be made of steel plate, for example. By means of fastening straps 12, the mounting element 11 can be attached to the outside of the wall 02 of the container. Because of the relatively great hardness of steel plate, it is not readily possible for the fastening edges of a polygonal element to dig into the mounting element 11. For this reason, the mounting element 11 has grooves 13 in which the windings of a helical spring 07 may be tilted. The relative installed position between the helical spring 07 and the mounting element 11 designed in the manner of an open prismatic cross section is shown schematically in FIG. 6.

FIGS. 6a and 6b show the mounting element according to FIG. 5 in an alternative embodiment as seen from the front.

FIGS. 7 and 8 show another embodiment 14 of a mounting element for use on inventive containers. The mounting element 14 is also designed in the manner of a flexible sheet metal part made of steel plate having grooving 13 for engagement of a helical spring 07, for example. An angled strap 15 is provided for attachment to the wall 02 of the container.

1. A container (01) having a handle body (04) that can be attached to the container (01), whereby a mounting element (03) is situated on the outside of the container (01) and whereby a recess (05) is provided in the handle body (04) so that the mounting element (03) can be inserted into the recess in a form-fitting manner, and whereby a fastening element (07) is engaged between the handle body (04) and the mounting element (03), securing the handle body (04) on the mounting element (03),
characterized in that
the fastening element is designed in the manner of a polygonal element (07) which can be brought to engagement with a plurality of fastening edges on the handle body (04) and/or on the mounting element (03) in a form-fitting and/or non-positive and/or frictionally engaged manner.

2. The container according to claim 1,
characterized in that
the inside clearance between the wall of the handle body (04) and the wall of the mounting element (04) in the area of the polygonal element (07) is at least slightly smaller than the corresponding width of the polygonal element (07), so that the polygonal element (07) is at least slightly deformed when situated between the handle body (04) and the mounting element (03).

3. The container according to claim 1,
characterized in that
the polygonal element (07) is arranged in an indentation (08) on the handle body (04) and/or on the mounting element, laterally guiding the polygonal element (07).

4. The container according to claim 3,
characterized in that
the indentation (08) has a stop surface (09) on the side facing away from the mounting element (03) such that the polygonal element (07) comes to rest against it when attaching the handle body (04).

5. The container according to claim 4,
characterized in that
the stop surface (09) is inclined with respect to the end cross section of the polygonal element (07) which is to be brought to rest against the stop surface (09).

6. The container according to claim 4,
characterized in that
a centering mandrel (10) for centering the polygonal element (07) in the indentation (08) is provided on the stop surface (09).

7. The container according to claim 1,
characterized in that
the fastening edges form a barb structure when the polygonal element (07) is positioned between the handle body (04) and the mounting element (06).

8. The container according to claim 1,
characterized in that
the polygonal element (07) is designed in the manner of a helical spring.

9. The container according to claim 8,
characterized in that
the helical spring (07) is manufactured from steel wire.

10. The container according to claim 8,
characterized in that
the steel wire has a diameter of approximately 0.1 mm to 5 mm.

11. The container according to claim 8,
characterized in that
the helical spring (07) has a diameter of 1 mm to 20 mm.

12. The container according to claim 1,
characterized in that
the handle body (04) is made of plastic, glass, ceramic, metal or wood.

13. The container according to claim 1,
characterized in that
the mounting element (03) is made of a soft material, in particular aluminum, whereby a form-fitting and/or non-positive and/or frictionally engaged surface structure is formed in the mounting element (03) by the fastening edges in the arrangement of the polygonal element (07) between the handle body (04) and the mounting element (03).

14. The container according to claim 1,
characterized in that
the mounting element (11, 14) is made of a hard metal, in particular steel, whereby the mounting element (11, 14) has a prefabricated surface structure, in particular grooving (13) for a form-fitting engagement of the fastening edges of the polygonal element (07).

15. The container according to claim 1,
characterized in that
the mounting element (03) is designed in the manner of a mounting bolt.

16. The container according to claim 1,
characterized in that
the mounting element (11, 14) is designed in the manner of a flexible sheet metal part.

17. The container according to claim 1,
characterized in that
the mounting element (03, 11, 14) has an open or closed prismatic, in particular rectangular cross section, whereby at least one polygonal element (07) comes to be engaged at a corner or edge of the mounting element (03, 11, 14).

18. The container according to claim 1,
characterized in that
the handle body (04) is designed in the manner of a side handle having a central fastening or in the manner of a side handle having a two-sided fastening or in the manner of a cover knob or in the manner of a loop handle or in the manner of a stem handle.

19. A handle body (04) having a mounting element (03) and a fastening element,
characterized in that
the handle body (04), the mounting element (03) and the fastening element are suitable for forming a container according to claim 1.
